(19) United States
(12) Patent Application Publication
(10) Pub. No.: US 2022/0311123 A1
(43) Pub. Date: Sep. 29, 2022

(54) BACK DOOR AND REAR WINDOW GLASS

(71) Applicant: AGC Inc., Tokyo (JP)

(72) Inventors: Akio MAMURO, Tokyo (JP); Naohito TORIUMI, Tokyo (JP); Jiro TAMURA, Tokyo (JP); Jun NODA, Tokyo (JP)

(73) Assignee: AGC Inc., Tokyo (JP)

(21) Appl. No.: 17/695,800

(22) Filed: Mar. 15, 2022

(30) Foreign Application Priority Data
Mar. 23, 2021 (JP) 2021-048834

(51) Int. Cl. H01Q 1/12; H01Q 1/32; H05B 3/84

(52) U.S. Cl. CPC H01Q 1/1278; H01Q 1/3283; H05B 3/84; H05B 2203/011

(57) ABSTRACT

A back door including an opening, includes: a resinous outer panel; a resinous inner panel; a metallic reinforce disposed between the outer panel and the inner panel; and a rear window glass covering the opening. The rear window glass includes: a defogger including a first bus bar that extends in an upper-lower direction, a second bus bar that is disposed apart from the first bus bar in a horizontal direction and extends in the upper-lower direction, and a plurality of heating wires that connect the first bus bar to the second bus bar; an auxiliary element connected to the defogger; and an antenna disposed so as to be surrounded by the defogger and the auxiliary element.

### CROSS-REFERENCE TO RELATED APPLICATIONS

The present application claims priority to Japanese Patent Application No. 2021-48834 filed on Mar. 23, 2021, the entire content of which is incorporated herein by reference.

### TECHNICAL FIELD

The present disclosure relates to a back door and a rear window glass.

### BACKGROUND ART

Some vehicles such as hatchback motor vehicles employ resinous back doors. In this case, a configuration is known in which a reinforce such as a metallic reinforcing frame is disposed in the periphery of an opening of the back door in order to heighten the rigidity of the back door. There are cases where a conductor such as a defogger or an antenna is disposed on the rear window glass to be attached to a back door. A configuration for use in such a rear window glass to be attached to a back door is known in which an auxiliary element which has branched off from the defogger is caused to achieve capacitive coupling with a metallic reinforcing frame grounded to the metallic body, thereby enabling the antenna to receive FM radio broadcast waves with high gain (see, for example Patent Document 1).
Patent Document 1: JP-A-2009-105665

### SUMMARY

However, since reinforces vary in shape and size depending on the constitutions, there are cases where sufficient antenna gain is not obtained even after antenna tuning, depending on the shape of the reinforce, etc.

The present disclosure provides a back door and a rear window glass which are equipped with an antenna that attains relatively high antenna gain.

The present disclosure provides a back door including an opening, the back door including:

a resinous outer panel;

a resinous inner panel;

a metallic reinforce disposed between the outer panel and the inner panel; and

a rear window glass covering the opening, in which the rear window glass includes:

a defogger including a first bus bar that extends in an upper-lower direction, a second bus bar that is disposed apart from the first bus bar in a horizontal direction and extends in the upper-lower direction, and a plurality of heating wires that connect the first bus bar to the second bus bar;

an auxiliary element connected to the defogger; and

an antenna disposed so as to be surrounded by the defogger and the auxiliary element.

The present disclosure further provides a rear window glass capable of being attached to a resinous back door including a metallic reinforce such that the rear window glass covers an opening formed in the back door,

the rear window glass including:

a defogger including a first bus bar that extends in a first direction, a second bus bar that is disposed apart from the first bus bar in a second direction perpendicular to the first direction and extends in the first direction, and a plurality of heating wires that connect the first bus bar to the second bus bar;

an auxiliary element connected to the defogger; and

an antenna disposed so as to be surrounded by the defogger and the auxiliary element.

The present disclosure can provide a back door and a rear window glass which are equipped with an antenna that attains relatively high antenna gain.

### BRIEF DESCRIPTION OF DRAWINGS

FIG. 1 is a plan view schematically illustrating a configuration example of a back door according to a first embodiment;

FIG. 2 is a diagram illustrating an example of a distribution of high-frequency current;

FIG. 3 is a plan view schematically illustrating a configuration example of a back door according to a second embodiment;

FIG. 4 is a diagram illustrating examples of an influence of differences in length a from a bus bar to an end of an auxiliary element on antenna characteristics in an FM broadcast frequency band;

FIG. 5 is a diagram illustrating examples of an influence of differences in minimum distance d between an antenna and an auxiliary element on antenna characteristics in an FM broadcast frequency band; and

FIG. 6 is a diagram illustrating examples of an influence of differences in gap length e on antenna characteristics in an FM broadcast frequency band.

### DETAILED DESCRIPTION

Embodiments of the present disclosure are explained below by reference to the drawings. For an easier understanding, the scales of portions or parts in the drawings may differ from actual ones. Directions such as parallel, perpendicular, orthogonal, horizontal, vertical, upper-lower, and right-left directions are allowed to deviate to such a degree as not to impair the effects of the embodiments. The shape of a corner portion is not limited to a right angle and may be arched. The terms “X-axis direction”, “Y-axis direction”, and “Z-axis direction” respectively mean a direction parallel with the X axis, a direction parallel with the Y axis, and a direction parallel with the Z axis. The X-axis direction, the Y-axis direction, and Z-axis direction are orthogonal to each other. The terms “XY plane”, YZ plane”, and “ZX plane” respectively mean a virtual plane parallel with both the X-axis direction and the Y-axis direction, a virtual plane parallel with both the Y-axis direction and the Z-axis direction, and a virtual plane parallel with both the Z-axis direction and the X-axis direction.

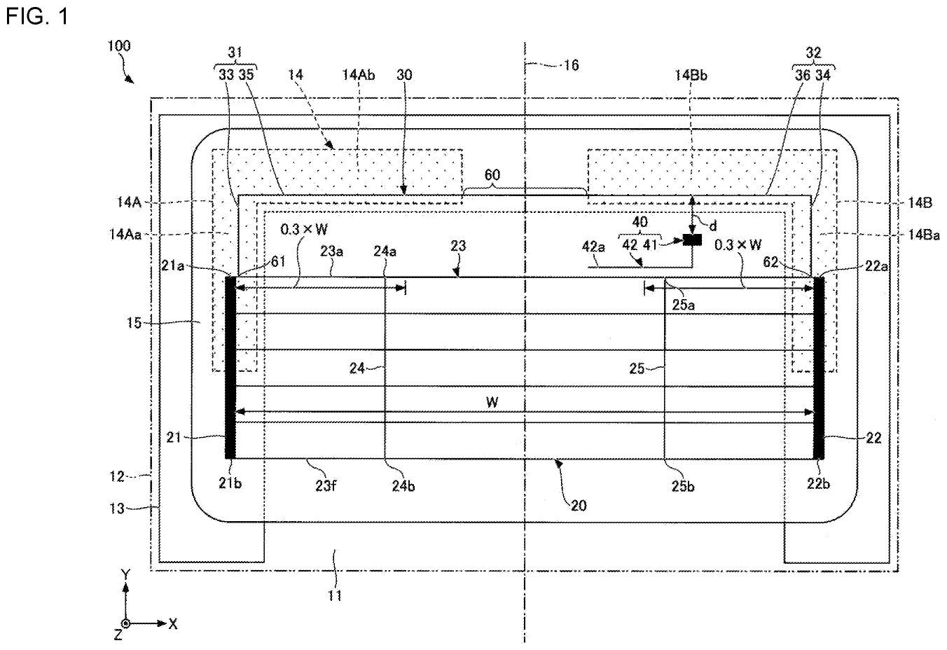

FIG. 1 is a plan view schematically illustrating a configuration example of a back door according to a first embodiment. The back door 100 illustrated in FIG. 1 is a resinous opening/closing object to be attached to a rear portion of a vehicle in an openable/closable manner, and includes an opening 11 for rear view from the vehicle. The back door 100 includes a resinous outer panel 12, a resinous inner panel 13, a metallic reinforce 14 disposed between the outer panel 12 and the inner panel 13, and a rear window glass 15 covering the opening 11.

Incidentally, FIG. 1 is a plan view illustrating the back door 100, viewed from outside the vehicle, from which the outer panel 12 has been removed. The X-axis direction approximately corresponds to the width direction of the vehicle (horizontal direction), and the Y-axis direction approximately corresponds to the upper-lower direction of the vehicle (vertical direction). The upper-lower direction is an example of a first direction, and the horizontal direction is an example of a second direction, which is perpendicular to the first direction. The shape of each portion or part illustrated in FIG. 1 is an example, and the shapes of the portions or parts in this disclosure are not limited to those illustrated in the drawing.

The outer panel 12 and the inner panel 13 are molded, for example, from a synthetic resin such as polypropylene or the like. The outer panel 12 is disposed on the outer side (more specifically on the vehicle rear side) of the inner panel 13.

The reinforce 14 is a metallic member to reinforce the back door 100 so as to improve the rigidity of the back door 100. The reinforce 14 is attached to either or both of the inner panel 13 and the outer panel 12 so that some or all of the opening 11 is surrounded by the reinforce 14. In the example illustrated in FIG. 1, the reinforce 14 is attached to the inner panel 13 and lies between the rear glass 15 and the inner panel 13 in the Z-axis direction.

The reinforce 14 is constituted of one or a plurality of members. In the example illustrated in FIG. 1, the reinforce 14 is constituted of members (a left-hand reinforce 14A and a right-hand reinforce 14B) separated right and left from each other (in the vehicle width direction). The left-hand reinforce 14A includes a left-hand reinforce portion 14Aa, which extends in the upper-lower direction in a region on the left-hand side of the opening 11, and an upper left-hand reinforce portion 14Ab, which extends in a region over the opening 11 rightward in the horizontal direction from the upper end of the left-hand reinforce portion 14Aa. The right-hand reinforce 14B includes a right-hand reinforce portion 14Ba, which extends in the upper-lower direction in a region on the right-hand side of the opening 11, and an upper right-hand reinforce portion 14Bb, which extends in a region over the opening 11 leftward in the horizontal direction from the upper end of the right-hand reinforce portion 14Ba. The left-hand reinforce portion 14Aa and the right-hand reinforce portion 14Ba are examples of vertical reinforce portions extending in the upper-lower direction. The upper left-hand reinforce portion 14Ab and the upper right-hand reinforce portion 14Bb are examples of horizontal reinforce portions connected to the vertical reinforce portions and extending in the horizontal direction.

In the examples illustrated in FIG. 1, the left-hand reinforce portion 14Aa and the upper left-hand reinforce portion 14Ab are constituted as a single member. However, these reinforcing portions may, for example, be constituted of two or more members joined to each other. Furthermore, the left-hand reinforce 14A may be separated into a plurality of members; for example, the left-hand reinforce portion 14Aa and the upper left-hand reinforce portion 14Ab may be separated from each other. Moreover, at least a part of the left-hand reinforce 14A may or may not overlie the rear window glass 15 or the opening 11, in a plan view of the rear window glass 15.

Likewise, in the example illustrated in FIG. 1, the right-hand reinforce portion 14Ba and the upper right-hand reinforce portion 14Bb are constituted as a single member. However, these reinforcing portions may, for example, be constituted of two or more members joined to each other. Furthermore, the right-hand reinforce 14B may be separated into a plurality of members; for example, the right-hand reinforce portion 14Ba and the upper right-hand reinforce portion 14Bb may be separated from each other. Moreover, at least a part of the right-hand reinforce 14B may or may not overlie the rear window glass 15 or the opening 11, in a plan view of the rear window glass 15.

The rear window glass 15 is a window glass attached to the resinous back door 100 so as to cover the opening 11 formed in the back door 100. The rear window glass 15 is attached to the inner panel 13 on the outer side (in this example, on the positive side in Z-axis direction) thereof.

The rear window glass 15 includes a defogger 20, an antenna 40, and an auxiliary element 30.

The defogger 20 is a conductor pattern of the electric heating type to defog the rear window glass 15 upon voltage application thereto. The defogger 20 includes a plurality of heating wires 23 extending in the right-left direction (horizontal direction) of the rear window glass 15 and a plurality of bus bars 21 and 22 which is configured to feed electricity to the plurality of heating wires 23. The plurality of heating wires 23 are heater wires which extend side by side with each other in the right-left direction (horizontal direction) of the rear window glass 15 and which connect the first bus bar 21 to the second bus bar 22.

The first bus bar 21 is a strip electrode extending in the upper-lower direction from an upper end 21a to a lower end 21b, and is wider than each of the heating wires 23. The second bus bar 22 is a strip electrode disposed apart from the first bus bar 21 in the horizontal direction and extending in the upper-lower direction from an upper end 22a to a lower end 22b, and is wider than each of the heating wires 23. Upon voltage application between the bus bars 21 and 22, the plurality of heating wires 23 heat up due to the electricity and, hence, the rear window glass 15 is defogged.

The antenna 40 is a conductor disposed so as to be surrounded by the defogger 20 and the auxiliary element 30. In the example illustrated in FIG. 1, the antenna 40 is surrounded by a closed loop formed by the defogger 20 and the auxiliary element 30.

The antenna 40 is formed so as to be capable of sending/receiving (sending or receiving or both) radio waves in a predetermined frequency band F₁, and resonates at frequencies in the frequency band F₁. The antenna 40 has a shape suitable for sending/receiving radio waves in a very high frequency (VHF) band with frequencies of 30-300 MHz. Among frequency bands included in the VHF band are an FM broadcast frequency band (76-108 MHz), DAB Band III (174-240 MHz), etc. The shape of the antenna 40 may be one capable of sending/receiving radio waves in a ultra-high frequency (UHF) band with frequencies of 300 MHz to 3 GHz. The antenna 40 may also be a 4GLTE antenna or a 5G (sub6) antenna, which can send/receive radio waves in a 3-6 GHz frequency band.

The auxiliary element 30 is a wire conductor connected to the defogger 20. In the example illustrated in FIG. 1, the auxiliary element 30 is connected to a heating wire 23a of the defogger 20. The heating wire 23a, among the plurality of heating wires 23, is nearest to the antenna 40; in this example, the heating wire 23a is the heating wire lying in an uppermost position among the plurality of heating wires 23. The auxiliary element 30 may have the function of a heating wire for defogging the rear window glass 15, or may be a conductor wire not having the function of a heating wire.

The auxiliary element 30 has a first element end 61, at which the auxiliary element 30 is connected to the defogger 20, and a second element end 62, at which the auxiliary element 30 is connected to the defogger 20. The auxiliary element 30 is an element ranging from the first element end 61 to the second element end 62 and helps to increase the antenna gain of the antenna 40.

The auxiliary element 30 has an intermediate portion 60 which includes a point where the auxiliary element 30 intersects a center line 16 of the rear window glass 15 or defogger 20. The intermediate portion 60 is a portion of the auxiliary element 30 which lies between the first element end 61 and the second element end 62. The center line 16 is a virtual line extending in the upper-lower direction and, in particular, corresponds to the axis of symmetry of the rear window glass 15 or defogger 20 which is symmetric with respect to a line in a plan view. The auxiliary element 30 may be or may not be symmetric with respect to the center line 16. In the example illustrated in FIG. 1, the intermediate portion 60 is explained as a portion where the auxiliary element 30 does not overlie the reinforce 14 in a plan view of the rear window glass 15.

In the first embodiment illustrated in FIG. 1, the antenna 40 is disposed so as to be surrounded by the defogger 20 and the auxiliary element 30. By additionally disposing the auxiliary element 30, the antenna capacity of the antenna 40 is increased and, hence, the frequencies at which the antenna 40 resonates can be shifted to the lower-frequency side. Meanwhile, the presence of the reinforce 14 results in a decrease in the antenna gain of the antenna 40. Consequently, even in cases when a frequency band (dip) where the antenna 40 has a reduced antenna gain due to the presence of the reinforce 14 lies within the frequency band to be used, the dip can be shifted to the outside of the frequency band to be used by additionally disposing the auxiliary element 30. For example, the auxiliary element 30 may shift the dip due to the presence of the reinforce 14 to the lower-frequency side or the higher-frequency side of the frequency band to be used. As a result, the antenna 40 has an improved average antenna gain in the frequency band F₁.

The auxiliary element 30 has a conductor portion extending, for example, along the reinforce 14. The conductor portion extending along the reinforce 14 is a portion extending parallel (or approximately parallel) with a surface portion or peripheral portion of the reinforce 14 in a plan view of the rear window glass 15. More specifically, that conductor portion is a portion extending parallel (or approximately parallel) with a direction in which the reinforce 14 extends. FIG. 1 shows a first adjacent portion 31 and a second adjacent portion 32 as examples of the conductor portion extending along the reinforce 14. The first adjacent portion 31 is an example of the conductor portion extending along the reinforce 14, and is adjacent to the left-hand reinforce 14A of the reinforce 14. The second adjacent portion 32 is an example of the conductor portion extending along the reinforce 14, and is adjacent to the right-hand reinforce 14B of the reinforce 14.

The auxiliary element 30, due to the adjacent portions thereof which are adjacent to the reinforce 14, achieves capacitive coupling with the reinforce 14. The term “adjacent portion” means an element portion of the auxiliary element 30 which is apart from the reinforce 14 at such a distance that the element portion can achieve capacitive coupling with the reinforce 14. The distance that renders capacitive coupling possible is, for example, longer than 0 mm and 50 mm or shorter, and may be longer than 0 mm and 30 mm or shorter. In the example illustrated in FIG. 1, the adjacent portions of the auxiliary element 30 overlie the reinforce 14 in the plan view of the rear window glass 15. However, so long as the adjacent portions are disposed at a distance that renders capacitive coupling possible, the adjacent portions may not overlie the reinforce 14 in the plan view of the rear window glass 15.

In the example illustrated in FIG. 1, the auxiliary element 30 includes the first adjacent portion 31, which extends along the left-hand reinforce 14A, and the second adjacent portion 32, which extends along the right-hand reinforce 14B. The first adjacent portion 31 is an example of a first conductor portion, which is nearer to the first bus bar 21 than to the second bus bar 22. The second adjacent portion 32 is an example of a second conductor portion, which is nearer to the second bus bar 22 than to the first bus bar 21.

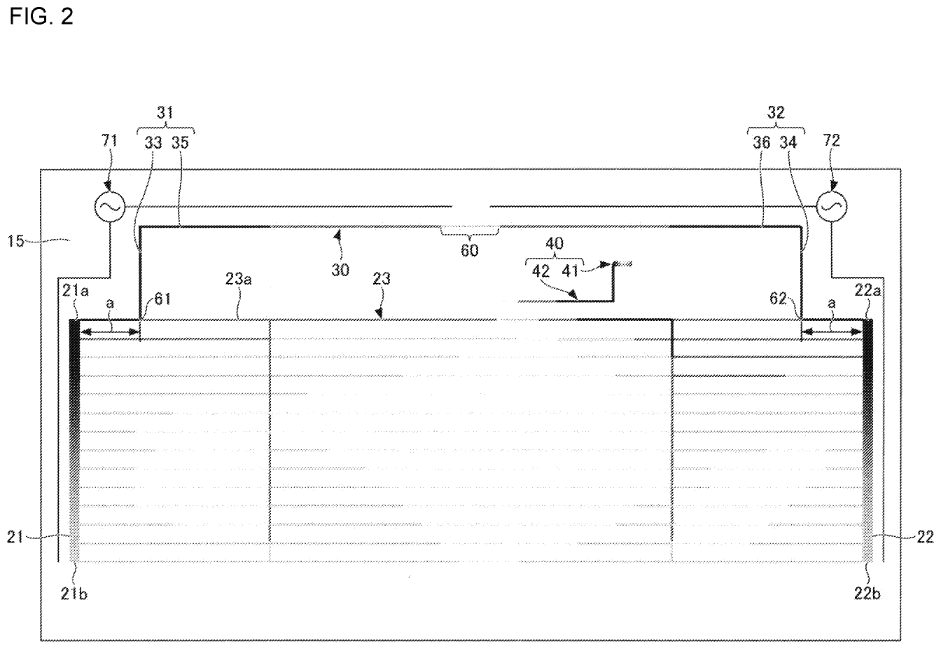

In the first embodiment illustrated in FIG. 1, the antenna 40 is disposed so as to be surrounded by the defogger 20 and the auxiliary element 30, and the auxiliary element 30 includes the adjacent portions extending along the reinforce 14. Due to this configuration, in the example illustrated in FIG. 1, a first dipole antenna 71 (see FIG. 2) having an overall length of λ/2 is virtually formed in a first route (hereinafter referred to also as “route L₁”) ranging from the intermediate portion 60 to the lower end 21b via the first adjacent portion 31 and the first bus bar 21. The lower end 21b is an example of the first end which is the end of the first bus bar 21 that is most apart from the first adjacent portion 31. Symbol λ, represents the wavelength in air of radio waves in a predetermined frequency band which are to be received by the antenna 40. Likewise, a second dipole antenna 72 (see FIG. 2) having an overall length of λ/2 is virtually formed in a second route (hereinafter referred to also as “route L₂”) ranging from the intermediate portion 60 to the lower end 22b via the second adjacent portion 32 and the second bus bar 22. The lower end 22b is an example of the second end which is the end of the second bus bar 22 that is most apart from the second adjacent portion 32. The end of the route L₁ (the end on the opposite side from the intermediate portion 60) may be not the lower end 21b of the first bus bar 21 but any point on the heating wire which, among the plurality of heating wires 23, is most apart from the first adjacent portion 31. Likewise, the end of the route L₂ (the end on the opposite side from the intermediate portion 60) may be not the lower end 22b of the second bus bar 22 but any point on the heating wire which, among the plurality of heating wires 23, is most apart from the second adjacent portion 32.

Consequently, the antenna 40 not only by itself receives radio waves in the frequency band F₁ but also can acquire, through the heating wire 23a of the defogger 20, radio waves in the frequency band F₁ received by the first dipole antenna 71, resulting in an improvement in antenna gain in the frequency band F₁. Furthermore, the antenna 40 can acquire, through the heating wire 23a of the defogger 20, radio waves in the frequency band F₁ received by the second dipole antenna 72, resulting in a further improvement in antenna gain in the frequency band F₁.

As described above, the first embodiment illustrated in FIG. 1 makes it possible to obtain a back door and a rear window glass which are equipped with an antenna attaining relatively high antenna gain. Even in cases when the configuration illustrated in FIG. 1 is reversed vertically or horizontally, the reversed configuration makes it possible to obtain a back door and a rear window glass which are equipped with an antenna attaining relatively high antenna gain.

The antenna 40 includes a feeding portion 41 and an antenna element 42 connected to the feeding portion 41. The antenna element 42 includes an element portion 42a which achieves capacitive coupling with the defogger 20. Due to the inclusion of this element portion 42a, the antenna 40 can efficiently acquire radio waves in the frequency band F₁ received by the first dipole antenna 71 and radio waves in the frequency band F₁ received by the second dipole antenna 72, through the heating wire 23a of the defogger 20. Thus, the antenna gain in the frequency band F₁ improves still further. In the example illustrated in FIG. 1, the element portion 42a extends along and is adjacent to the heating wire 23a, thereby achieving capacitive coupling with the heating wire 23a. The distance between the element portion 42a and the heating wire 23a may be, for example, 30 mm or less, or 20 mm or less, or 10 mm or less. A lower limit of the distance is not particularly limited so long as the distance is longer than 0 mm, and the distance may be, for example, 3 mm or longer.

The received signals obtained via the antenna 40 are taken out through the feeding portion 41. The signals taken out through the feeding portion 41 are transmitted to an input unit of an amplifier (not illustrated) via an electroconductive member conductively connected to the feeding portion 41. Specific examples of the electroconductive member include feeding lines such as AV wires and coaxial cables. The amplifier is configured to amplify the signals taken out through the feeding portion 41 and outputs the amplified signals to a signal processing circuit (not illustrated) mounted on the vehicle.

In the case of using a coaxial cable as a feeding line, the core wire (inner conductor) of the coaxial cable is connected to the feeding portion 41 and the outer conductor of the coaxial cable is connected to the vehicle body or to a ground (vehicle body ground) such as a metallic portion electrically connected to the vehicle body. The metallic portion electrically connected to the vehicle body may be, for example, the reinforce 14. A connector for connecting the amplifier to the feeding portion 41 may be used. This connector is mounted, for example, in the feeding portion 41. The amplifier may be mounted in the connector. The antenna 40 may be what is called a monopole antenna, which has only one feeding portion 41, or may be a dipole antenna that has two feeding portions 41, one of which is connected to the core wire of a coaxial cable and the other is connected to the outer conductor of the coaxial cable.

FIG. 2 is a diagram illustrating an example of a distribution of high-frequency current, in which the higher the color density, the higher the high-frequency current flowing therethrough. The wire conductor portions extending from the first adjacent portion 31, which achieves capacitive coupling with the left-hand reinforce 14A grounded to the vehicle body, on both sides thereof (in this case, downward and rightward) function as the first dipole antenna 71, which resonates in the frequency band F₁. Likewise, the wire conductor portions extending from the second adjacent portion 32, which achieves capacitive coupling with the right-hand reinforce 14B grounded to the vehicle body, on both sides thereof (in this case, downward and leftward) function as the second dipole antenna 72, which resonates in the frequency band F₁.

In FIG. 2, the route L₁ ranging from the intermediate portion 60 to the lower end 21b is a route including a first conducting route (hereinafter referred to also as “conducting route CL₁”). The conducting route CL₁ is a route at least including the first adjacent portion 31, which extends along the left-hand reinforce 14A. The length of this conducting route CL₁ corresponds to the length of the first dipole antenna 71. Likewise, the route L₂ ranging from the intermediate portion 60 to the lower end 22b is a route including a second conducting route (hereinafter referred to also as “conducting route CL₂”). The conducting route CL₂ is a route at least including the second adjacent portion 32, which extends along the right-hand reinforce 14B. The length of this conducting route CL₂ corresponds to the length of the second dipole antenna 72.

A wavelength in air of radio waves in a given frequency band F₁ which are to be received by the antenna 40 is expressed by k, and a wavelength shortening ratio of the rear window glass 15 is expressed by k. In cases when the conducting route CL₁ and/or the conducting route CL₂ has a length L of 0.90×λ/2×k or longer and 1.10×λ/2×k or shorter, antenna gain in the frequency band F₁ is improved. From the standpoint of improving the antenna gain in the frequency band F₁, the length L of the at least one conducting route is preferably 0.92×λ/2×k or longer and 1.08×λ/2×k or shorter, more preferably 0.94×λ/2×k or longer and 1.06×λ/2×k or shorter.

In FIG. 1, in cases when the first adjacent portion 31 includes a first vertical adjacent portion 33, which extends in the upper-lower direction along the left-hand reinforce portion 14Aa extending in the upper-lower direction, then the antenna gain in sending/receiving vertically polarized waves in the frequency band F₁ is improved. Likewise, in cases when the second adjacent portion 32 includes a second vertical adjacent portion 34, which extends in the upper-lower direction along the right-hand reinforce portion 14Ba extending in the upper-lower direction, then the antenna gain in sending/receiving vertically polarized waves in the frequency band F₁ is improved. The first vertical adjacent portion 33 is an example of a vertical conductor portion extending along a vertical reinforce portion extending in the upper-lower direction, and is adjacent to the left-hand reinforce 14Aa. The second vertical adjacent portion 34 is an example of a vertical conductor portion extending along a vertical reinforce portion extending in the upper-lower direction, and is adjacent to the right-hand reinforce 14Ba.

In cases when the first adjacent portion 31 includes a first horizontal adjacent portion 35, which extends in the horizontal direction along the upper left-hand reinforce portion 14Ab extending in the horizontal direction, then the antenna gain in sending/receiving horizontally polarized waves in the frequency band F₁ is improved. Likewise, in cases when the second adjacent portion 32 includes a second horizontal adjacent portion 36, which extends in the horizontal direction along the upper right-hand reinforce portion 14Bb extending in the horizontal direction, then the antenna gain in sending/receiving horizontally polarized waves in the frequency band F₁ is improved. The first horizontal adjacent portion 35 is an example of a horizontal conductor portion extending along a horizontal reinforce portion, and is adjacent to the upper left-hand reinforce 14Ab. The second horizontal adjacent portion 36 is an example of a horizontal conductor portion extending along a horizontal reinforce portion, and is adjacent to the upper right-hand reinforce 14Bb.

In cases when the first adjacent portion 31 overlies the left-hand reinforce 14A in a plan view of the rear window glass 15, this facilitates capacitive coupling with the left-hand reinforce 14A in the Z-axis direction. Thus, the coupling strength increases, resulting in an improvement in antenna gain in the frequency band F₁. Likewise, in cases when the second adjacent portion 32 overlies the right-hand reinforce 14B in the plan view of the rear window glass 15, this facilitates capacitive coupling with the right-hand reinforce 14B in the Z-axis direction. Thus, the coupling strength increases, resulting in an improvement in antenna gain in the frequency band F₁.

In cases when the conducting route ranging from the first vertical adjacent portion 33 to the lower end 21b has a length L_{Q1} of 0.95×λ/4×k or longer and 1.05×λ/4×k or shorter, then the antenna gain in sending/receiving vertically polarized waves in the frequency band F₁ is improved. That is, in cases when the length (L_{Q1}) over which the first vertical adjacent portion 33 and the first bus bar 21 extend in the upper-lower direction (Y-axis direction) along the left-hand reinforce 14A is within the aforementioned range, then the antenna gain for vertically polarized waves in the frequency band F₁ is improved. From the standpoint of improving the antenna gain in sending/receiving vertically polarized waves in the frequency band F₁, the length L_{Q1} is preferably 0.96×λ/4×k or longer and 1.04×λ/4×k or shorter, more preferably 0.97×λ/4×k or longer and 1.03×λ/4×k or shorter. Incidentally, the starting point of the length L_{Q1} may be any point within the first vertical adjacent portion 33. The ending point of the length L_{Q1} need not be the lower end 21b of the first bus bar 21 and may be any point on the heating wire 23f which, among the plurality of heating wires 23, is most apart from the first adjacent portion 31.

In cases when the conducting route ranging from the second vertical adjacent portion 34 to the lower end 22b has a length L_{Q2} of 0.95×λ/4×k or longer and 1.05×λ/4×k or shorter, then the antenna gain in sending/receiving vertically polarized waves in the frequency band F₁ is improved. That is, in cases when the length (L_{Q2}) over which the second vertical adjacent portion 34 and the second bus bar 22 extend in the upper-lower direction (Y-axis direction) along the right-hand reinforce 14B is within the aforementioned range, then the antenna gain for vertically polarized waves in the frequency band F₁ is improved. From the standpoint of improving the antenna gain in sending/receiving vertically polarized waves in the frequency band F₁, the length L_{Q2} is preferably 0.96×λ/4×k or longer and 1.04×λ/4×k or shorter, more preferably 0.97×λ/4×k or longer and 1.03×λ/4×k or shorter. Incidentally, the starting point of the length L_{Q2} may be any point within the second vertical adjacent portion 34. The ending point of the length L_{Q2} need not be the lower end 22b of the second bus bar 22 and may be any point on the heating wire 23f which, among the plurality of heating wires 23, is most apart from the second adjacent portion 32.

In cases when the defogger 20 includes one or more short-circuiting wires which short-circuit the plurality of heating wires 23 in the upper-lower direction, the antenna gain in the frequency band F₁ is improved. In the example illustrated in FIG. 1, the defogger 20 includes: a short-circuiting wire 24 which short-circuits the plurality of heating wires 23 in the upper-lower direction between the center line 16 and the first bus bar 21; and a short-circuiting wire 25 which short-circuits the plurality of heating wires 23 in the upper-lower direction between the center line 16 and the second bus bar 22. The defogger 20 may further have a short-circuiting wire extending along the center line 16 (for example, a short-circuiting wire which short-circuits the plurality of heating wires 23 in the upper-lower direction between the short-circuiting wire 24 and the short-circuiting wire 25), although such a short-circuiting wire is not illustrated in FIG. 1. The short-circuiting wire 24, for example, has an upper end 24a connected to the heating wire 23a, which, among the plurality of heating wires 23, is nearest to the antenna 40, and a lower end 24b connected to the heating wire 23f, which, among the plurality of heating wires 23, is most apart from the antenna 40. The short-circuiting wire 25, for example, has an upper end 25a connected to the heating wire 23a and a lower end 25b connected to the heating wire 23f.

Here, in cases when a route ranging from the intermediate portion 60 to any point on the heating wire 23f via the first adjacent portion 31 and the short-circuiting wire 24 is referred to as route L₃ and when the route L₃ has a length of 0.90×λ/2×k or longer and 1.10×λ/2×k or shorter, then the antenna gain in the frequency band F₁ is improved. Any point on the heating wire 23f is an example of a route end on a heating wire which, among the plurality of heating wires 23, is most apart from the first adjacent portion 31. Incidentally, in the case where the lower end 24b of the short-circuiting wire 24 does not lie on the heating wire 23f, the route end of the route L₃ is not any point on the heating wire 23f and may be the lower end 24b. The lower end 24b in this case is an example of a wire end which, among the wire ends of the short-circuiting wire 24, is most apart from the first adjacent portion 31. Especially in the case where the first vertical adjacent portion 33 of the auxiliary element 30 is connected to a point nearer to the short-circuiting wire 24 than to the first bus bar 21, then high-frequency current flows through the route L₃ in an increased amount and the route L₃, via the short-circuiting wire 24, functions as a dipole antenna together with the first dipole antenna of the route L₁. Also in this case, the antenna 40 has an increased antenna gain due to these dipole antennas.

Likewise, in cases when a route ranging from the intermediate portion 60 to any point on the heating wire 23f via the second adjacent portion 32 and the short-circuiting wire 25 is referred to as route L₃ and when the route L₃ has a length of 0.90×λ/2×k or longer and 1.10×λ/2×k or shorter, then the antenna gain in the frequency band F₁ is improved. Any point on the heating wire 23f is an example of a route end on a heating wire which, among the plurality of heating wires 23, is most apart from the second adjacent portion 32. Incidentally, in the case where the lower end 25b of the short-circuiting wire 25 does not lie on the heating wire 23f, the route end of the route L₃ is not any point on the heating wire 23f and may be the lower end 25b. The lower end 25b in this case is an example of a wire end which, among the wire ends of the short-circuiting wire 25, is most apart from the second adjacent portion 32. Especially in the case where the second vertical adjacent portion 34 of the auxiliary element 30 is connected to a point nearer to the short-circuiting wire 25 than to the second bus bar 22, then high-frequency current flows through the route L₃ in an increased amount and the route L₃, although including the short-circuiting wire 25, functions as a dipole antenna together with the second dipole antenna of the route L₂. Also in this case, the antenna 40 has an increased antenna gain due to these dipole antennas.

From the standpoint of improving the antenna gain in the frequency band F₁, the length of the route L₃ is preferably 0.92×λ/2×k or longer and 1.08×λ/2×k or shorter, more preferably 0.94×λ/2×k or longer and 1.06×λ/2×k or shorter.

The horizontal-direction width of the defogger 20 (distance between the first bus bar 21 and the second bus bar 22) is expressed by W. In cases when the first element end 61, where the auxiliary element 30 is connected to the defogger 20, lies in the range of from a horizontal-direction end (first bus bar 21) of the defogger 20 to a point being 0.3×W away in a horizontal direction from the horizontal-direction end, the antenna gain in the frequency band F₁ is improved. From the standpoint of improving the antenna gain in the frequency band F₁, the first element end 61 lies preferably in the range of from the first bus bar 21 to a point being 0.2×W away in the horizontal direction from the first bus bar 21, more preferably in the range of from the first bus bar 21 to a point being 0.1×W away in the horizontal direction from the first bus bar 21, and still more preferably is connected to the first bus bar 21.

Likewise, in cases when the second element end 62, where the auxiliary element 30 is connected to the defogger 20, lies in the range of from a horizontal-direction end (second bus bar 22) of the defogger 20 to a point being 0.3×W away in the horizontal direction from the horizontal-direction end, the antenna gain in the frequency band F₁ is improved. From the standpoint of improving the antenna gain in the frequency band F₁, the second element end 62 lies preferably in the range of from the second bus bar 22 to a point being 0.2×W away in the horizontal direction from the second bus bar 22, more preferably in the range of from the second bus bar 22 to a point being 0.1×W away in the horizontal direction from the second bus bar 22, and still more preferably is connected to the second bus bar 22. Furthermore, in cases when the auxiliary element 30 is connected to the defogger 20 at points near the first bus bar 21 and the second bus bar 22, then the first vertical adjacent portion 33 and the second vertical adjacent portion 34 of the auxiliary element 30 are disposed respectively in left-hand and right-hand end areas of the rear window glass 15, making the auxiliary element 30 less apt to narrow the view.

In cases when the minimum distance d between the antenna 40 and the auxiliary element 30 is 10 mm or longer, the antenna gain in the frequency band F₁ is improved. In the example illustrated in FIG. 1, the minimum distance d corresponds to the distance between the auxiliary element 30 and the feeding portion 41. From the standpoint of improving the antenna gain in the frequency band F₁, the minimum distance d is preferably 15 mm or longer, more preferably 20 mm or longer, still more preferably 30 mm or longer, especially preferably 40 mm or longer, most preferably 50 mm or longer. There is no particular upper limit on the minimum distance d so long as an area sufficient for disposing the antenna 40 can be ensured.

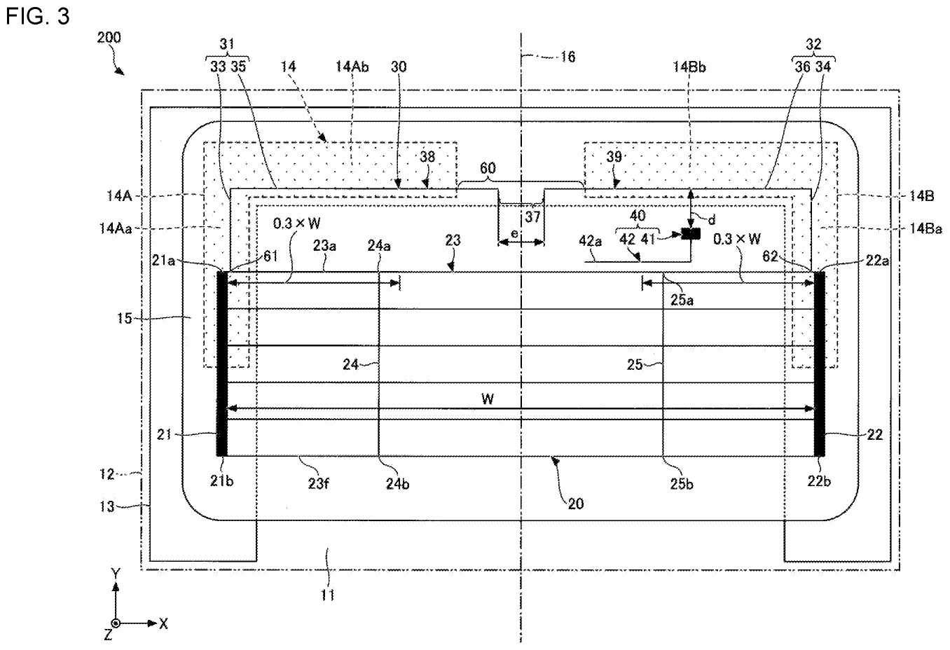

FIG. 3 is a plan view schematically illustrating a configuration example of a back door according to a second embodiment. With respect to the second embodiment, explanations on the same configurations as in the first embodiment are omitted by quoting the explanations given above. The back door 200 according to the second embodiment illustrated in FIG. 3 differs from the back door 100 according to the first embodiment in that there is a gap 37 in the intermediate portion 60.

The auxiliary element 30 includes a first auxiliary element 38 and a second auxiliary element 39, which face each other with the gap 37 therebetween. Although the auxiliary element 30 has the gap 37 therein, the antenna 40 is disposed so as to be surrounded by the defogger 20 and the auxiliary element 30. Incidentally, the configuration where “the antenna 40 is disposed so as to be surrounded by the defogger 20 and the auxiliary element 30” encompasses not only a configuration where the defogger 20 and the auxiliary element 30 form a closed loop but also a configuration where the gap 37 is present between a plurality of the auxiliary elements like this embodiment, for example.

Consequently, like the first embodiment, the second embodiment makes it possible to obtain a back door and a rear window glass which are equipped with an antenna attaining relatively high antenna gain. Even in cases when the configuration illustrated in FIG. 3 is reversed vertically or horizontally, the reversed configuration makes it possible to obtain a back door and a rear window glass which are equipped with an antenna attaining relatively high antenna gain.

In cases when the gap 37 has a length e of 300 mm or less, the antenna gain in the frequency band F₁ is improved. From the standpoint of improving the antenna gain in the frequency band F₁, the length of the gap 37 is preferably 200 mm or less, more preferably 100 mm or less, still more preferably 50 mm or less, especially preferably 20 mm or less, most preferably 10 mm or less.

In the example illustrated in FIG. 3, the gap 37 intersects the center line 16. However, the gap 37 may lie apart from the center line 16 without intersecting the center line 16. In cases when the gap 37 lies not in a portion of the auxiliary element 30 which extends in the upper-lower direction (Y-axis direction) but in a portion thereof which extends in the horizontal direction (X-axis direction), it is likely to improve the antenna gain especially for vertically polarized electromagnetic waves in the frequency band F₁. In the example illustrated in FIG. 3, the gap 37 intersects the center line 16 and, in a plan view of the rear window glass 15, the intermediate portion 60 corresponds to both a portion where the auxiliary element 30 does not overlie the reinforce 14 and the portion occupied by the gap 37.

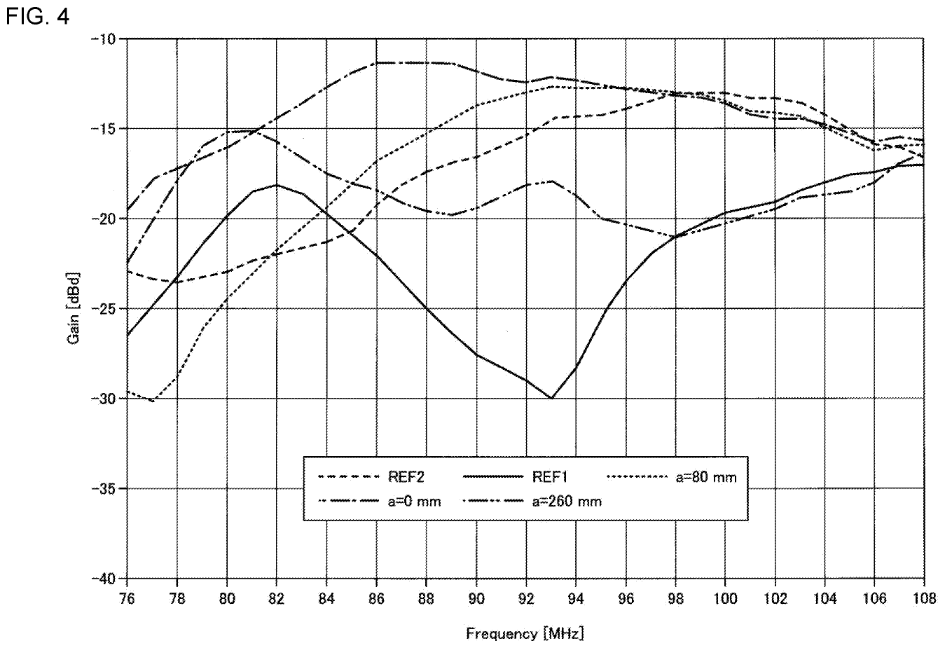

FIG. 4 is a diagram illustrating examples of an influence of differences in length a (see FIG. 2) from a bus bar to an element end of the auxiliary element in the back door 100 (see FIG. 1) according to the first embodiment on antenna characteristics in an FM broadcast frequency band. The differences in length a are caused by differences in the position where the auxiliary element 30 is connected to the defogger 20.

In FIG. 4, “REF1” indicates a case, as a comparative example, in which the auxiliary element 30 has been removed from the configuration illustrated in FIG. 1. “REF2” indicates a case, as a reference example, in which the reinforce 14 and the auxiliary element 30 have been removed from the configuration illustrated in FIG. 1. “a=260 mm” indicates a case of the configuration illustrated in FIG. 1 in which the first element end 61 is directly connected to the upper end 24a of the short-circuiting wire 24 and the second element end 62 is directly connected to the upper end 25a of the short-circuiting wire 25.

In the cases of “a=80 mm” and “a=260 mm”, the first element end 61 lies in the range of from the first bus bar 21 to a point being 0.3×W away from the first bus bar 21 and the second element end 62 lies in the range of from the second bus bar 22 to a point being 0.3×W away from the second bus bar 22. In the case of “a=0 mm”, the first element end 61 is connected to the first bus bar 21 and the second element end 62 is connected to the second bus bar 22. In particular, under the conditions of “a=80 mm” and “a=0 mm”, the auxiliary element 30 is disposed so as to overlie at least the left-hand reinforce portion 14Aa and the right-hand reinforce portion 14Ba in a plan view of the rear window glass 15 to achieve capacitive coupling with each of these reinforce portions.

The wavelength shortening ratio k of the rear window glass 15 is taken as 0.7, and the wavelength λ in air of radio waves in an FM broadcast frequency band F₁ (76-108 MHz) is in the range of 2,776-3,945 mm. Hence, (λ/2)×k is in the range of 972-1,381 mm and (λ/4)×k is in the range of 486-690 mm. In the cases of “a=80 mm” and “a=0 mm”, “(λ/2) k”, which is included in the expressions indicating preferred ranges of the conducting route CL₁ and conducting route CL₂, was regulated to 972-1,381 mm and “(λ/4)×k”, which is included in the expressions indicating preferred ranges of the conducting route L_{Q1} and conducting route L_{Q2}, was regulated to 486-690 mm. Furthermore, in the case of “a=260 mm”, the length of the route L₃ was regulated to a value in the range of 972-1,381 mm, which corresponds to (λ/2)×k.

From the data shown in FIG. 4, average antenna gains for frequencies within the FM broadcast frequency band were calculated as follows.

REF1: −22.4 (dBd)

REF2: −14.7 (dBd)

a=260 mm: −19.1 (dBd)

a=80 mm: −14.0 (dBd)

a=0 mm: −13.4 (dBd)

As demonstrated above, the cases where the back doors each included an auxiliary element 30 had improved average antenna gains in the FM broadcast frequency band, as compared with REF1, in which the back door included a reinforce 14 but included no auxiliary element 30. The obtained results indicate that the case in which the first element end 61 was connected to the first bus bar 21 and the second element end 62 was connected to the second bus bar 22 was the highest in average antenna gain.

In measurements, the results of which are shown in FIG. 4, the dimensions of portions illustrated in FIG. 1 were taken as below.

Length of the antenna element 42: 280 mm (80 mm (vertical)+200 mm (horizontal))

Spacing between the antenna element 42 and the heating wire 23a: 5 mm

Horizontal distance from the center line 16 to the short-circuiting wire 24: 300 mm

Horizontal distance from the center line 16 to the short-circuiting wire 25: 295 mm

Minimum distance between the auxiliary element 30 and the reinforce 14: 12.6 mm

W: 1,138 mm

d: 30 mm

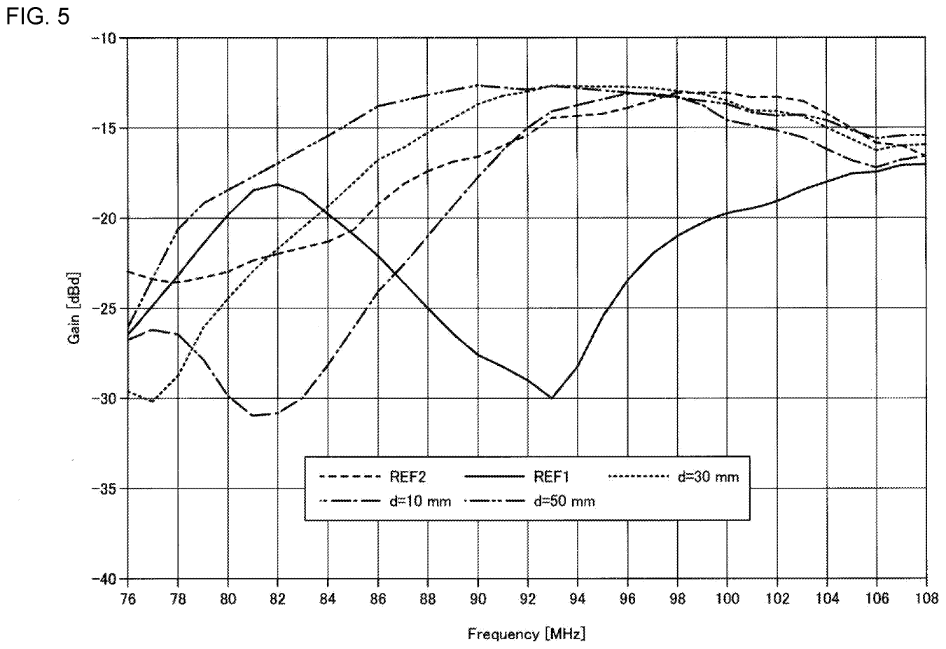

FIG. 5 is a diagram showing examples of an influence of differences in minimum distance d between the antenna 40 and the auxiliary element 30 in the back door 100 (see FIG. 1) according to the first embodiment on antenna characteristics in an FM broadcast frequency band.

From the data shown in FIG. 5, average antenna gains for frequencies within the FM broadcast frequency band were calculated as follows.

REF1: −22.4 (dBd)

REF2: −14.7 (dBd)

d=10 mm: −15.6 (dBd)

d=30 mm: −14.0 (dBd)

d=50 mm: −13.7 (dBd)

That is, the obtained results show that the longer the minimum distance d between the antenna 40 and the auxiliary element 30, the higher the average antenna gain.

In making measurements, the results of which are shown in FIG. 5, the dimensions of portions illustrated in FIG. 1 were the same as in the measurements for FIG. 4 except that the value a was fixed at a=80 mm. As demonstrated above, the inclusion of the auxiliary element 30 attains a higher average antenna gain than REF1. Furthermore, even under the conditions of d=10 mm, a further increase in average antenna gain is attained by reducing the value a to less than 80 mm to dispose the auxiliary element 30 so as to achieve enhanced capacitive coupling with the left-hand reinforce portion 14Aa and with the right-hand reinforce portion 14Ba.

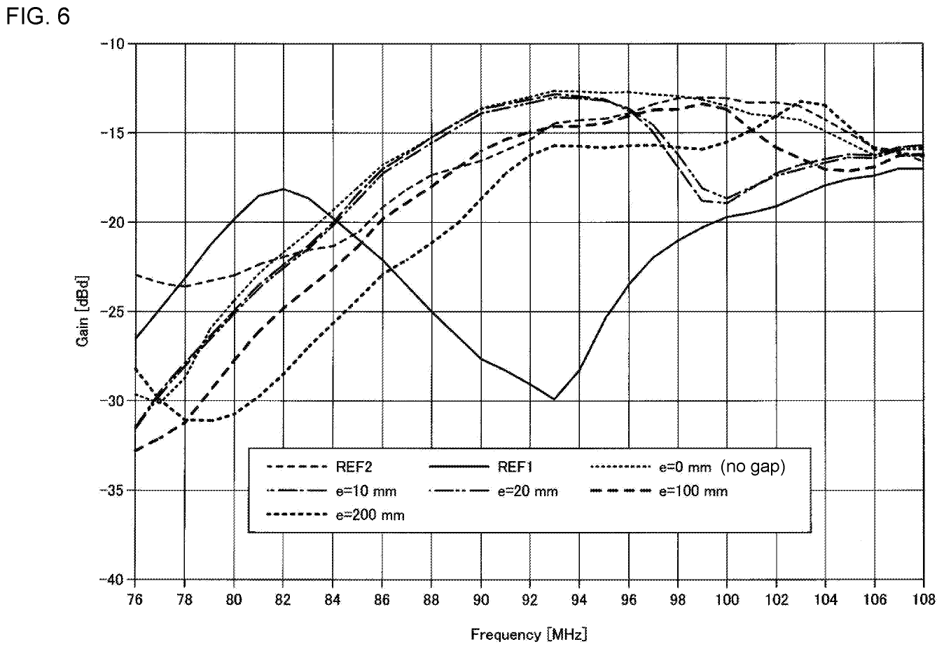

FIG. 6 is a diagram showing examples of an influence of differences in the length e of the gap 37 in the back door 200 (see FIG. 3) according to the second embodiment on antenna characteristics in an FM broadcast frequency band. The expression “e=0 mm (no gap)” indicates the case of the back door 100 (see FIG. 1) according to the first embodiment.

From the data shown in FIG. 6, average antenna gains for frequencies within the FM broadcast frequency band were calculated as follows.

REF1: −22.4 (dBd)

REF2: −14.7 (dBd)

e=0 mm: −14.0 (dBd)

e=10 mm: −15.5 (dBd)

e=20 mm: −15.5 (dBd)

e=100 mm: −15.4 (dBd)

e=200 mm: −16.1 (dBd)

As demonstrated above, even in the cases where the auxiliary element 30 has a gap 37, average antenna gains are higher than REF1. In making measurements, the results of which are shown in FIG. 6, the dimensions of portions illustrated in FIG. 1 were set as a=80 mm and d=30 mm. However, even under the conditions of e=10 mm to e=200 mm, a further increase in average antenna gain is attained by reducing the value a to shorter than 80 mm and increasing the value d to longer than 30 mm. That is, even in cases when the length e of the gap 37 is increased to some degree, a sufficient antenna gain can be ensured.

While embodiments have been described above, the present disclosure is not limited to the embodiments and can be variously modified or improved, for example, by combining any of the embodiments with some or all of another embodiment or replacing some of any of the embodiments by some or all of another embodiment.

For example, an “end” of an element may be a starting point or ending point of an extension of the element, or may be a near-starting-point portion or near-ending-point portion which is a conductor portion before the starting point or ending point. Furthermore, an “end” of an element may have a bend or a fold. The term “end” can mean “one end”, “the other end”, “leading end”, “trailing end”, or “open end”. Elements may be connected to each other so that the connected portions have a curvature.

The antenna element and the electrode (feeding portion) are each formed, for example, by printing a paste containing an electroconductive metal (e.g., a silver paste) on a surface of a window glass, the surface being to face an inside of vehicles, and baking the paste. However, methods for forming the antenna element and electrode are not limited to the method. For example, the antenna element or the electrode may be formed by disposing a wire-shaped or foil-shaped object including an electroconductive material such as copper on a surface of a window glass, the surface being to face the inside of vehicles, or a surface of a window glass, the surface being to face the outside of vehicles. Alternatively, the antenna element or the electrode may be adhered to the window glass with an adhesive or the like, or may be disposed in an inner portion of the window glass itself.

The shape of the electrode (feeding portion) is preferably a quadrilateral shape such as a square, approximately square, rectangular, or approximately rectangular shape, or a polygonal shape, from the standpoint of mounting. The shape of the electrode may be a circular shape such as a circle, an approximate circle, an ellipse, or an approximate ellipse.

Moreover, a configuration may be employed in which a conductor layer for forming the antenna element and/or the electrode is disposed inside a synthetic-resin film or on a surface thereof and the synthetic-resin film with the conductor layer is disposed on a surface of window glass, the surface being to face the inside of vehicles, or a surface of window glass, the surface being to face the outside of vehicles. Furthermore, a configuration may be employed in which a flexible circuit board having the antenna element and/or the electrode formed thereon is disposed on a surface of window glass, the surface being to face the inside of vehicles, or a surface of window glass, the surface being to face the outside of vehicles.

### REFERENCE SIGNS LIST

11 Opening
12 Outer panel
13 Inner panel
14 Reinforce
15 Rear window glass
16 Center line
20 Defogger
21 First bus bar
21a, 22a Upper end
21b, 22b Lower end
22 Second bus bar
23, 23a, 23f Heating wire
24, 25 Short-circuiting wire
30 Auxiliary element
31, 32 Adjacent portion
33 First vertical adjacent portion
34 Second vertical adjacent portion
35 First horizontal adjacent portion
36 Second horizontal adjacent portion
37 Gap
38 First auxiliary element
39 Second auxiliary element
40 Antenna
41 Feeding portion
42 Antenna element
42a Element portion
60 Intermediate portion
61 First element end
62 Second element end
71, 72 Dipole antenna
100, 200 Back door

What is claimed is:

1. A back door including an opening, the back door comprising:
a resinous outer panel;
a resinous inner panel;
a metallic reinforce disposed between the outer panel and the inner panel; and
a rear window glass covering the opening,
wherein the rear window glass comprises:
a defogger comprising a first bus bar that extends in an upper-lower direction, a second bus bar that is disposed apart from the first bus bar in a horizontal direction and extends in the upper-lower direction, and a plurality of heating wires that connect the first bus bar to the second bus bar;
an auxiliary element connected to the defogger; and
an antenna disposed so as to be surrounded by the defogger and the auxiliary element.

2. The back door according to claim 1, wherein the auxiliary element comprises a conductor portion extending along the reinforce.

3. The back door according to claim 2, wherein the reinforce comprises a vertical reinforce portion extending in the upper-lower direction, and
the conductor portion comprises a vertical conductor portion extending along the vertical reinforce portion.

4. The back door according to claim 3, wherein the reinforce comprises a horizontal reinforce portion connected to the vertical reinforce portion and extending in the horizontal direction, and
the conductor portion comprises a horizontal conductor portion extending along the horizontal reinforce portion.

5. The back door according to claim 2, wherein the conductor portion overlies the reinforce in a plan view of the rear window glass.

6. The back door according to claim 2, wherein the auxiliary element comprises an intermediate portion which intersects a center line of the rear window glass or of the defogger, the center line extending in the upper-lower direction, and
when a wavelength in air of radio waves in a given frequency band that are to be received by the antenna is λ, a wavelength shortening ratio of the rear window glass is k, and an end of the first bus bar or of the plurality of heating wires which is most apart from the conductor portion is referred to as a first end,
a route from the intermediate portion to the first end via the conductor portion and the first bus bar includes a first conducting route, wherein the first conducting route includes at least the conductor portion,
the first conducting route has a length of 0.90×λ/2×k or longer and 1.10×λ/2×k or shorter.

7. The back door according to claim 2, wherein:
the auxiliary element includes an intermediate portion which intersects a center line of the rear window glass or of the defogger, the center line extending in the upper-lower direction;
the conductor portion includes a first conductor portion, which is nearer to the first bus bar than to the second bus bar, and a second conductor portion, which is nearer to the second bus bar than to the first bus bar; and
when a wavelength in air of radio waves in a given frequency band which are to be received by the antenna is λ, a wavelength shortening ratio of the rear window glass is k, an end of the first bus bar or of the plurality of heating wires which is most apart from the first conductor portion is referred to as a first end, and an end of the second bus bar or of the plurality of heating wires which is most apart from the second conductor portion is referred to as a second end,
a first route from the intermediate portion to the first end via the first conductor portion and the first bus bar includes a first conducting route, the first conducting route at least including the first conductor portion,
a second route from the intermediate portion to the second end via the second conductor portion and the second bus bar includes a second conducting route, the second conducting route at least including the second conductor portion, and
at least one of the first conducing route or the second conducting route has a length of 0.90×λ/2×k or longer and 1.10×λ/2×k or shorter.

8. The back door according to claim 2, wherein the conductor portion is adjacent to the reinforce.

9. The back door according to claim 1, wherein the defogger comprises a short-circuiting wire that short-circuits the plurality of heating wires in the upper-lower direction.

10. The back door according to claim 9, wherein:
the auxiliary element comprises a conductor portion extending along the reinforce and an intermediate portion which intersects a center line of the rear window glass or of the defogger, the center line being extending in the upper-lower direction; and
when a wavelength in air of radio waves in a given frequency band which are to be received by the antenna is λ, a wavelength shortening ratio of the rear window glass is k, and a wire end of the short-circuiting wire which, among the wire ends of the short circuiting wire, is most apart from the conductor portion or a point on the plurality of heating wires which, among any points on the heating wires, is most apart from the conductor portion is referred to as a route end,
a route from the intermediate portion to the route end via the conductor portion and the short-circuiting wire has a length of 0.90×λ/2×k or longer and 1.10×λ/2×k or shorter.

11. The back door according to claim 1, wherein the auxiliary element is connected to at least one of the first bus bar or the second bus bar.

12. The back door according to claim 1, wherein the antenna is surrounded by a closed loop formed by the defogger and the auxiliary element.

13. The back door according to claim 1, wherein the auxiliary element includes a first auxiliary element and a second auxiliary element, which face each other with a gap between the first auxiliary element and the second auxiliary element.

14. The back door according to claim 13, wherein the gap intersects a center line of the rear window glass or of the defogger, the center line extending in the upper-lower direction.

15. The back door according to claim 1, wherein the auxiliary element is symmetric with respect to a center line of the rear window glass or of the defogger, the center line extending in the upper-lower direction.

16. The back door according to claim 13, wherein the gap does not intersect a center line of the rear window glass or of the defogger, the center line extending in the upper-lower direction.

17. The back door according to claim 1, wherein:
the antenna comprises a feeding portion and an antenna element connected to the feeding portion; and
the antenna element comprises an element portion which achieves capacitive coupling with the defogger.

18. The back door according to claim 1, wherein when a horizontal-direction width of the defogger is W, a portion where the auxiliary element is connected to the defogger lies in a range of from each horizontal-direction end of the defogger to a point being 0.3×W away in the horizontal direction from the each horizontal-direction end.

19. The back door according to claim 1, wherein a minimum distance between the antenna and the auxiliary element is 10 mm or longer.

20. A rear window glass, comprising:
a defogger comprising a first bus bar that extends in a first direction, a second bus bar that is disposed apart from the first bus bar in a second direction perpendicular to the first direction and extends in the first direction, and a plurality of heating wires that connect the first bus bar to the second bus bar;
an auxiliary element connected to the defogger; and
an antenna disposed so as to be surrounded by the defogger and the auxiliary element.
